(19) United States
(12) Patent Application Publication
(10) Pub. No.: US 2025/0050625 A1
(43) Pub. Date: Feb. 13, 2025

(54) LAMINATED GLASS HAVING IMPROVED RESIDUAL LOAD-BEARING CAPABILITY

(71) Applicants: SCHOTT Technical Glass Solutions GmbH, Jena (DE); SCHOTT Glass Ibérica, S.L., Barcelona (ES)

(72) Inventors: Matthias Franke, Rudolstadt (DE); Jens Klossek, Weimar (DE); Anja Kaufmann, Vallgorguina (ES)

(73) Assignees: SCHOTT Technical Glass Solutions GmbH, Jena (DE); SCHOTT Glass Ibérica, S.L., Barcelona (ES)

(21) Appl. No.: 18/722,838

(22) PCT Filed: Dec. 20, 2022
(86) PCT No.: PCT/EP2022/086955

§ 371 Date: Jun. 21, 2024

(30) Foreign Application Priority Data
Dec. 21, 2021 (DE) 10 2021 134 101.9
Dec. 20, 2022 (WO) PCTEP2022086955

(51) Int. Cl. B32B 17/10

(52) U.S. Cl. CPC B32B 17/1077; B32B 17/10036; B32B 17/10568; B32B 17/10935; B32B 2307/3065; B32B 2307/542; B32B 2307/714; B32B 2307/7376

(57) ABSTRACT

The present invention relates to a laminated glass with improved residual load-bearing capacity. The laminated glass comprises at least two sheets of glass or glass-ceramic joined to one another through an interlayer. The laminated glass may be used in particular as overhead glazing. The laminated glass is particularly suitable for use as safety glass and/or fire-resistant glass.

### CROSS-REFERENCE TO RELATED APPLICATIONS

This application is a national stage entry under 35 U.S.C. § 371 of International Patent Application No. PCT/EP2022/086955 entitled “LAMINATED GLASS HAVING IMPROVED RESIDUAL LOAD-BEARING CAPACITY,” filed on Dec. 20, 2022, which is incorporated in its entirety herein by reference. International Patent Application No. PCT/EP2022/086955 claims priority to German Patent Application No. 10 2021 134 101.9 filed on Dec. 21, 2021, which is incorporated in its entirety herein by reference.

### BACKGROUND OF THE INVENTION

### 1. Technical Field of the Invention

The present invention relates to a laminated glass with improved residual load-bearing capacity. The laminated glass comprises at least two sheets of glass or glass-ceramic joined to one another through an interlayer. The laminated glass may be used in particular as overhead glazing. The laminated glass is particularly suitable for use as safety glass and/or fire-resistant glass.

### 2. Description of the Related Art

Laminated glasses are known from the prior art. In general they constitute a laminate of at least two glass or glass-ceramic sheets joined to one another via a plastic interlayer. A disadvantage of the known laminated glasses is their limited residual load-bearing capacity. In the event of damage to such laminated glasses, more particularly to one or more sheets in the laminate, they are often no longer able to carry additional weight and they begin to sag under their own weight or to delaminate, with the possible consequence of detachment of the laminate or parts thereof from the frame mounting. This harbors the potential for dangers, in some cases considerable, especially since the sheets typically have a high weight and, moreover, even relatively small fragments can have sharp edges. Furthermore, there may also be damage to articles hit by sheets or parts of sheets. The greatest danger in this respect is posed by overhead glazing.

Against this background, it is an object of the invention to overcome the disadvantages from the prior art. The intention in particular is to provide a laminated glass with improved residual load-bearing capacity that is outstandingly suitable for overhead glazing.

### SUMMARY OF THE INVENTION

In one aspect, the invention relates to laminated glass comprising at least two sheets and an interlayer located between the two sheets and composed of an interlayer material
where the ratio of the sum of the wavinesses (each in mm per 300 mm) of the two sheets to the thickness (in mm) of the interlayer is at most 1.0% per mm,
where the interlayer material comprises at least one polymer and has a melting temperature of at most 220° C., and
where the two sheets independently of one another are glass sheets or glass-ceramic sheets.

In one aspect, the laminated glass consists of the two sheets and the interlayer. Optionally there is just one interlayer located between the sheets, and in particular no further layers. It is also possible to provide an additional coating on one or both sheets, more particularly on the side remote from the interlayer. In some embodiments, there may be one or more further sheets present.

In a further aspect, the invention relates to laminated glass comprising at least one first and one second sheet and an interlayer located between the two sheets and composed of an interlayer material,
where the two sheets independently of one another are glass sheets or glass-ceramic sheets,
where the first sheet in the context of the determination of the waviness has a gap of greatest height Hₘₐₓ₁ having the x-y coordinates (x₁, y₁) and the second sheet in the context of the determination of the waviness has a gap of greatest height Hₘₐₓ₂ having the x-y coordinates (x₂, y₂), and
where the two sheets are arranged in the laminated glass in such a way that the gap having the greatest height on the first sheet (Hₘₐₓ₁) differs from the gap having the greatest height on the second sheet (Hₘₐₓ₂) in terms of the coordinates in such a way that |x₁−x₂|≥5 mm and/or |y₁−y₂|≥5 mm.

### BRIEF DESCRIPTION OF THE DRAWINGS

FIG. 1 shows a measuring apparatus for determining a shear strength;

FIG. 2 shows a typical force-displacement curve of example A;

FIG. 3 shows a typical force-displacement curve of example C; and

FIG. 4 shows, schematically, the determination of the waviness of a sheet.

### DETAILED DESCRIPTION OF THE INVENTION

Laminated glasses with poor residual load-bearing capacity tend to react to damage by sagging under their own weight or delaminating, with the possible consequence of detachment of the laminate or parts thereof from the frame mounting. For laminated glasses having good residual load-bearing capacity, this tendency is much less pronounced. The residual load-bearing capacity therefore denotes the capacity of the laminated glass, after the fracture of a sheet, still to be able to carry its own weight. The residual load-bearing capacity of the laminated glass is determined essentially by the extent of the adhesion between the sheets and the plastic interlayer, which is also reflected in good shear strength. This extent is dependent in turn on a plurality of parameters. Of particular importance are the waviness of the sheets, the thickness of the interlayer, and the melting temperature of the interlayer material.

The laminated glass of the invention comprises at least two sheets and an interlayer located between the two sheets and composed of an interlayer material. Each of the two sheets has a certain waviness.

The waviness of the sheets has negative consequences. This is because a pronounced waviness hinders uniform contact between sheet and interlayer, meaning that the adhesion may be reduced. This effect may be countered by increasing the thickness of the interlayer. Particularly thick interlayers, however, are generally not desired, and so compensating for the waviness of the sheet by raising the thickness of the interlayer is advantageous only within certain bounds.

The waviness of each of the two sheets may be determined by placing a measuring body having a planar measuring face, more particularly a ruler, with a length of 300 mm onto the side of the sheet remote from the interlayer, such that the measuring body does not overhang any of the edges of the sheet. The waviness might equally be determined by measuring not the side remote from the interlayer but instead the side facing the interlayer. It is more practicable, however, to measure the side remote from the interlayer since this measurement can be performed nondestructively on the laminated glass.

The TTV (Total Thickness Variation) of the sheets is small in particular in comparison to the waviness. The waviness may therefore be described, without differentiation between the two sides of the sheet, as a parameter of the sheet as such, and may be determined representatively on each of the two sides by measurement with the measuring body.

The TTV is determined as the difference between the maximum and the minimum thicknesses of a sheet. Each of the sheets, for example, may have a TTV of at most 0.4 mm, at most 0.3 mm or at most 0.2 mm. The ratio of the waviness (in mm per 300 mm) to the TTV (in mm) may for each of the sheets, for example, be in a range from 1.0 to 20.0 per meter, more particularly in a range from 2.0 to 15.0 per meter, or in a range from 5.0 to 10.0 per meter. The ratio of the waviness to the TTV may be for example at least 1.0 per meter, 2.0 per meter, or 5.0 per meter. The ratio of the waviness to the TTV may be for example at most 20.0 per meter, at most 15.0 per meter, or 10.0 per meter.

The measuring body for measuring the waviness will generally lie at two or more points on the sheet, while because of the waviness of the sheet, a gap between the measuring body and the sheet surface is produced at another location. The height of such gaps may be determined, for example, with a feeler gauge, more particularly by placing the feeler gauge between the sheet surface and the measuring body and increasing the thickness of the feeler gauge until the gap between the sheet surface and the measuring body is just filled at the location of the greatest distance between the sheet surface and the measuring body. The thickness of the feeler gauge then corresponds to the height of the gap. Gaps with different heights may come about depending on the position in which the measuring body is placed on the sheet surface. The gap relevant for determining the waviness is the gap which has the greatest height of all the gaps. This height is also denoted Hₘₐₓ and expressed in the unit mm. The waviness of the sheet is expressed as the ratio of Hₘₐₓ (in mm) to the length of the measuring body, of 300 mm. After shortening of the unit mm, the waviness may be expressed as a percentage figure. If, for example, Hₘₐₓ is 3 mm, the waviness is the product of the ratio of 3 mm to 300 mm and accordingly is 1.0%.

The waviness of the two sheets of the laminated glass is not inevitably identical. In practice, the two sheets will in fact frequently have a different thickness. The sum of the wavinesses of the two sheets is of practical importance, as it is a decisive co-determinant of the extent of the variation in the inter-sheet space. This sum ought to be as low as possible. To a certain degree, the disadvantages of a high total waviness may be countered by a relatively large interlayer thickness, as described above.

The ratio of the sum of the wavinesses (each in mm per 300 mm) of the two sheets to the thickness (in mm) of the interlayer ought, however, not to exceed a value of 1.0% per mm. In particularly preferred embodiments, the ratio of the sum of the wavinesses of the two sheets to the thickness of the interlayer is in fact only at most 0.9% per mm, at most 0.8% per mm, at most 0.7% per mm, at most 0.6% per mm, at most 0.5% per mm or at most 0.4% per mm. It is also possible when producing the laminated glass to take care that the two sheets are arranged with respect to one another in such a way that no particularly large inter-sheet spaces result from the fact that wave crests and wave troughs of the two sheets are arranged straight opposite one another. The sheets in particular may be arranged in such a way that the gap having the greatest height on the first sheet (Hₘₐₓ₁) and the gap having the greatest height on the second sheet (Hₘₐₓ₂) are not directly opposite each other in the laminated glass. Wave troughs and wave crests are generally at regular spacings as a result of the production process. Avoidance of opposing wave troughs will therefore likewise avoid opposing wave crests.

To specify the position of a gap on a sheet, it is possible for example to stipulate a system of coordinates in which one of the corners of the sheet has the x-y coordinates (0,0), while the coordinates of the opposite corner of the sheet correspond directly to the length and width of the sheet. For a sheet having a length of 2000 mn and a width of 1000 mm, the x-y coordinates of the four corners of the sheet are for example (0 mm, 0 mm), (0 mm, 1000 mm), (2000 mm, 0 mm) and (2000 mm, 1000 mm). In a laminated glass, corresponding positions of the two sheets each have the same x-y coordinates. The point having the coordinates (250 mm, 500 mm) on the first sheet is therefore, for example, exactly opposite the point having the coordinates (250 mm, 500 mm) on the second sheet.

The gap having the greatest height on the first sheet (Hₘₐₓ₁) has the x-y coordinates (x₁, y₁). The gap having the greatest height on the second sheet (Hₘₐₓ₂) has the x-y coordinates (x₂, y₂). In the laminated glass, the two sheets are preferably arranged in such a way that the gap having the greatest height on the first sheet (Hₘₐₓ₁) differs from the gap having the greatest height on the second sheet (Hₘₐₓ₂) in terms of the coordinates in such a way that |x₁−x₂|≥5 mm and/or |y₁−y₂|≥5 mm. Optionally, |x₁−x₂|≥10 mm and/or |y₁−y₂|≥10 mm, more particularly |x₁−x₂|≥15 mm and/or |y₁−y₂|≥15 mm or |x₁−x₂|≥20 mm and/or |y₁−y₂|≥20 mm.

Another effect that can be used to counter the problem of sheet waviness is the flow behavior of the interlayer material. If an interlayer material having good flow properties is used, the waviness of the sheet can be compensated, at any rate partly, by heating the interlayer material, when producing the laminated glass, to a temperature which allows the material to flow into waviness-induced defects or locations with little interlayer material or to expand at least that far. Temperatures used for this purpose, however, ought not to be arbitrarily high. Interlayer materials having proven advantageous are therefore those which possess a relatively low melting temperature. The melting temperature is situated preferably in a range from 180 to 220° C., for example from 190 to 210° C. Unless otherwise indicated, the melting temperature in the present disclosure refers to the melting temperature under standard pressure (101.325 kPa). The melting temperature of the interlayer material is at most 220° C., for example at most 210° C. The melting temperature of the interlayer material may for example be at least 180° C. or at least 190° C.

At least one of the two sheets, preferably each of the two sheets, may for example have a thickness in a range from 2.0 to 15.0 mm, more particularly from 2.0 to 10.0 mm, from 2.5 to 7.5 mm, from 3.0 to 6.0 mm, or from 3.5 to 5.5 mm. The thickness of at least one of the two sheets, more particularly each of the two sheets, may be for example at least 2.0 mm, at least 2.5 mm, at least 3.0 mm, or at least 3.5 mm. The thickness of at least one of the two sheets, more particularly of each of the two sheets, may be for example at most 15.0 mm, at most 10.0 mm, at most 7.5 mm, at most 6.0 mm, or at most 5.5 mm.

The interlayer may for example have a thickness in a range from 0.3 to 5.0 mm, more particularly from 0.4 to 4.0 mm, from 0.5 to 3.0 mm, from 0.6 to 2.0 mm, or from 0.7 to 1.0 mm. The thickness of the interlayer may be for example at least 0.3 mm, at least 0.4 mm, at least 0.5 mm, at least 0.6 mm, or at least 0.7 mm. The thickness of the interlayer may be for example at most 5.0 mm, at most 4.0 mm, at most 3.0 mm, at most 2.0 mm, or at most 1.0 mm.

The laminated glass may for example have a thickness in a range from 5.0 to 15.0 mm, more particularly in a range from 6.0 to 14.0 mm, from 7.0 to 13.0 mm, from 8.0 to 12.0 mm, or from 9.0 to 11.0 mm. the thickness of the laminated glass may be for example at least 5.0 mm, at least 6.0 mm, at least 7.0 mm, at least 8.0 mm, or at least 9.0 mm. The thickness of the laminated glass may be for example at most 15.0 mm, at most 14.0 mm, at most 13.0 mm, at most 12.0 mm, or at most 11.0 mm.

The two sheets may independently of one another be glass sheets or glass-ceramic sheets. In some embodiments, both sheets are glass sheets, especially borosilicate glass sheets. In some embodiments, both sheets are glass-ceramic sheets. In some embodiments, one of the two sheets is a glass sheet, especially a borosilicate glass sheet, and the other of the two sheets is a glass-ceramic sheet. In certain embodiments, at least one of the two sheets is a glass sheet, especially a borosilicate glass sheet. In certain embodiments, at most one of the two sheets is a glass sheet, especially a borosilicate glass sheet. In certain embodiments, at most one of the two sheets is a glass-ceramic sheet. In certain embodiments, at least one of the two sheets is a borosilicate glass sheet or a glass-ceramic sheet. In certain embodiments, both sheets are glass-ceramic sheets or borosilicate glass sheets.

A glass sheet may in particular be a soda-lime glass sheet or a borosilicate glass sheet. Borosilicate glasses herein denote, in particular, glasses which have a B₂O₃ fraction in a range from 7% to 15% by weight.

A glass-ceramic sheet is a sheet which consists of a glass-ceramic. A glass sheet is a sheet which consists of a glass. A soda-lime glass sheet is a sheet which consists of a soda-lime glass. A borosilicate glass sheet is a sheet which consists of a borosilicate glass, more particularly of a glass which has a B₂O₃ fraction in a range from 7% to 15% by weight.

The interlayer material comprises a polymer. The polymer may for example be polyurethane (PU).

In one aspect of the invention, the laminated glasses have fire protection properties. With the laminated glass of the invention, a fire resistance class as per DIN EN 13501-1:2010-01 of at least EW 60 is preferably achieved, more preferably at least EW 90, more preferably at least EW 120.

With the laminated glass of the invention it is possible for example to achieve a fire resistance class as per DIN EN 13501-1:2010-01 of at least E 30, at least E 60, at least E 90, at least E 120, or at least E 180.

With the composite glass of the invention it is possible for example to achieve a fire resistance class of at least UL9 or at least UL10, in particular including the hose stream test. The fire resistant times may be for example at least 45 minutes, at least 60 minutes, at least 90 minutes, at least 120 minutes, or at least 180 minutes.

The interlayer material may for example comprise, additionally to the polymer, a flame-retardant material or a combination of two or more flame-retardant materials.

The flame-retardant material may in particular be selected from the group consisting of bromine-containing compounds (more particularly polybrominated diphenyl ethers (PBDE), brominated alcohols, and/or polybrominated cycloalkanes), phosphate-containing compounds, chlorinated compounds, inorganic flame retardants (more particularly aluminum hydroxide), and combinations of two or more thereof. The flame-retardant material is preferably selected from the group consisting of polybrominated diphenyl ethers, brominated alcohols, polybrominated cycloalkanes, phosphate-containing compounds, and combinations of two or more thereof.

The polybrominated diphenyl ethers may in particular be decabromodiphenyl ethers.

The brominated alcohols may for example be selected from the group consisting of dibromoneopentyl alcohol, tribromoneopentyl alcohol, tetrabromobisphenol A (TBBA), dibromobutenediol, and combinations of two or more thereof.

The polybrominated cycloalkane may for example be hexabromocyclodecane (HBCD).

The phosphate-containing compound may for example be selected from the group consisting of tricresyl phosphate, cresyl diphenyl phosphate, dicresyl phenyl phosphate, triphenyl phosphate and combinations of two or more thereof.

The flame-retardant material may in particular be selected from the group consisting of tricresyl phosphate, cresyl diphenyl phosphate, dicresyl phenyl phosphate, triphenyl phosphate and combinations of two or more thereof.

The flame-retardant material may in particular be selected from the group consisting of dibromoneopentyl alcohol, tribromoneopentyl alcohol, tetrabromobisphenol A (TBBA), dibromobutenediol and combinations of two or more thereof.

The flame-retardant material may in particular be selected from the group consisting of tricresyl phosphate, cresyl diphenyl phosphate, dicresyl phenyl phosphate, triphenyl phosphate, dibromoneopentyl alcohol, tribromoneopentyl alcohol, tetrabromobisphenol A (TBBA), dibromobutenediol and combinations of two or more thereof.

A disadvantage of laminated glasses from the prior art is that in the event of fire they tend to sag sharply. This is attributable at least partly to a pronounced expansion in volume of the interlayer material, in particular at relatively low temperatures. This so-called outgassing of the interlayer material can lead to a massive buildup in pressure in the laminated glass, which may in turn be associated with sagging of the laminated glass and the incidence of fractures of the sheets.

To counter such disadvantages, it may be advantageous to choose the interlayer material such that it has a relatively large fraction of inorganic substances which are unable to form gas pressure. Alternatively or additionally, it may be advantageous if the decomposition of the interlayer material is relatively slow, especially at comparatively low temperatures. If the buildup of pressure is slower, there is an improvement in the possibility for reduction of pressure via the edge regions of the laminated glass, which by that point are already open. At somewhat higher temperatures, however, more rapid decomposition is advantageous. It makes it possible to prevent pronounced decomposition phenomena occurring at particularly high temperatures, since at these particularly high temperatures a large part of the interlayer material has in that case already decomposed and so is no longer available for further decomposition phenomena. Otherwise, gases escaping on the non-fire side in the event of later decomposition might ignite as a result of temperatures which are already too high.

The interlayer material may in particular be chosen such that the interlayer material has one or more of the following properties:
a relatively large fraction of inorganic substances which are unable to form gas pressure,
a slow decomposition at low temperatures (especially at temperatures in a range from 100° C. to 200° C.), and/or
a rapid decomposition at moderate temperatures (especially at temperatures in a range from 275° C. to 425° C.).

The fraction of inorganic substances which are unable to form gas pressure is relatively large when the interlayer material is chosen such that it has a high residue on ignition. The residue on ignition may be determined as per DIN EN ISO 3451-1:2019-05 (Plastics-Determination of ash—Part 1: General methods). For determining the residue on ignition, the interlayer material is heated in particular to a temperature of 625° C., until the organic compounds have burned and only the inorganic fraction (the so-called residue on ignition) remains. The residue on ignition is generally expressed as a weight fraction relative to the total mass of the material studied. The residue on ignition of the interlayer material as per DIN EN ISO 3451-1:2019-05 (at a temperature of 625° C.) may for example be at least 0.20% by weight, at least 0.25% by weight, or at least 0.30% by weight. These lower limits characterize the aforementioned large residue on ignition. The residue on ignition of the interlayer material as per DIN EN ISO 3451-1:2019-05 (at a temperature of 625° C.) may for example be at most 0.75% by weight, at most 0.50% by weight, or at most 0.40% by weight. The residue on ignition of the interlayer material as per DIN EN ISO 3451-1:2019-05 (at a temperature of 625° C.) may be situated for example in a range from 0.20% to 0.75% by weight, from 0.25% to 0.50% by weight, or from 0.30% to 0.40% by weight.

Differential scanning calorimetry (DSC), also called differential thermoanalysis, is a method with which it is possible to measure the heat given off or absorbed by an interlayer material when this material is heated. This method is particularly suitable for determining the extent of the decomposition of the material at low temperatures. The method may be carried out in particular according to DIN EN ISO 11357-1:2017-02 (Plastics-Differential scanning calorimetry (DSC)). In particular it is possible to employ what is called power-compensated DSC. In this case, a sample of the interlayer material and a reference crucible are introduced into thermally insulated ovens and these ovens are regulated such that the temperature on both sides is always the same. The power required for such regulation may be determined as a function of the temperature. The interlayer material may in particular be chosen in such a way that the electrical power required in the power-compensated DSC in a temperature range from 100° C. to 200° C. is on average at most 0.60 mW per mg of interlayer material. The required power may for example also be less than 0.60 mW/mg, in particular at most 0.55 mW/mg. The required power may for example be at least 0.40 mW/mg, in particular more than 0.40 mW/mg or at least 0.45 mW/mg. The required power may for example be situated in a range from 0.40 to 0.60 mW/mg, from >0.40 to <0.60 mW/mg, or from 0.45 to 0.55 mW/mg.

A method which enables particularly effective determination of the decomposition at relatively high temperatures is that known as thermogravimetric analysis (TGA). In contrast to DSC, a TGA determines not the change in heat but rather the change in mass. With TGA, a sample is subjected to a defined heating program. The loss of mass occurring as a function of the temperature is measured and characterizes the thermal decomposition. The TGA may take place according to DIN EN ISO 11358-1:2014-10. In particular, the samples are heated from 25° C. to 600° C. under nitrogen (30 ml N₂/min) with a heating rate of 20 K/min. The interlayer material may be chosen for example such that 50% by weight of the loss of mass of the interlayer material in the TGA takes place at temperatures below 425° C., more particularly below 420° C., below 410° C., below 400° C., below 390° C., or below 380° C. 50% by weight of the loss of mass of the interlayer material in the TGA may for example take place at temperatures above 325° C., above 330° C., above 340° C., above 350° C., above 360° C., or above 370° C. 50% by weight of the loss of mass of the interlayer material in the TGA may take place for example at temperatures in a range from 325 to 425° C., from 330 to 420° C., from 340 to 410° C., from 350 to 400° C., from 360 to 390° C., or from 370 to 380° C. The limiting values stated for the loss of mass characterize the aforementioned slow decomposition at low temperatures and rapid decomposition at moderate temperatures, respectively.

The interlayer material may for example have a density in a range from 1.00 to 1.25 g/cm³, from 1.01 to 1.15 g/cm³, from 1.02 to 1.10 g/cm³, or from 1.03 to 1.05 g/cm³. The density of the interlayer material may for example be at least 1.00 g/cm³, at least 1.01 g/cm³, at least 1.02 g/cm³, or at least 1.03 g/cm³. The density may for example be at most 1.25 g/cm³, at most 1.20 g/cm³, at most 1.15 g/cm³, at most 1.10 g/cm³, at most 1.09 g/cm³, at most 1.08 g/cm³, at most 1.07 g/cm³, at most 1.06 g/cm³, or at most 1.05 g/cm³. A low density is advantageous for low weight of the laminated glass. The density of the interlayer material may be determined according to ASTM D792, more particularly according to ASTM D792:2020.

The interlayer material may for example have a Shore hardness (Shore A) in a range from 50 to 95, 60 to 90, from 65 to 85, or from 70 to 80. The Shore hardness (Shore A) may for example be at least 50, at least 60, at least 65 or at least 70. The Shore hardness (Shore A) may for example be at most 95, at most 90, at most 85, or at most 80. The Shore hardness may be determined according to ASTM D2240-00.

The interlayer material may for example have a strain at 100% elongation in a range from 5.0 to 15.0 MPa, from 6.0 to 14.0 MPa, from 7.0 to 13.0 MPa, or from 8.0 to 12.0 MPa. The strain at 100% elongation may for example be at least 5.0 MPa, at least 6.0 MPa, at least 7.0 MPa, or at least 8.0 MPa. The strain at 100% elongation may for example be at most 15.0 MPa, at most 14.0 MPa, at most 13.0 MPa, or at most 12.0 MPa. The strain at 100% elongation may be determined according to ASTM D412, more particularly according to ASTM D412-16 (2021).

The interlayer material may for example have a strain at 300% elongation in a range from 10.0 to 25.0 MPa, from 11.0 to 24.0 to MPa, from 12.0 to 23.0 MPa, from 13.0 to 22.0 MPa, from 14.0 to 21.0 MPa, or from 15.0 to 20.0 MPa. The strain at 300% elongation may for example be at least 10.0 MPa, at least 11.0 MPa, at least 12.0 MPa, at least 13.0 MPa, at least 14.0 MPa, or at least 15.0 MPa. The strain at 300% elongation may for example be at most 25.0 MPa, at most 24.0 MPa, at most 23.0 MPa, at most 22.0 MPa, at most 21.0 MPa, or at most 20.0 Mpa. The strain at 300% elongation may be determined according to ASTM D412, more particularly according to ASTM D412-16 (2021).

The tensile strength of the interlayer material may for example be in a range from 5.0 to 50.0 MPa, from 10.0 to 40.0 MPa, from 15.0 to 30.0 MPa, or from 17.0 to 25.0 MPa. The tensile strength of the interlayer material may for example be at least 5.0 MPa, at least 10.0 MPa, at least 15.0 MPa, or at least 17.0 MPa. The tensile strength of the interlayer material may for example be at most 50.0 MPa, at most 40.0 MPa, at most 30.0 MPa, or at most 25.0 MPa. The tensile strength may be determined according to ASTM D412, more particularly according to ASTM D412-16 (2021).

The interlayer material may for example have an elasticity modulus to 10% elongation in a range from 10.0 to 30.0 MPa, from 12.5 to 27.5 MPa, from 15.0 to 25.0 MPa, or from 16.5 to 21.5 MPa. The interlayer material may for example have an elasticity modulus to 10% elongation of at least 10.0 MPa, at least 12.5 MPa, at least 15.0 MPa or at least 16.5 MPa. The interlayer material may for example have an elasticity modulus to 10% elongation of at most 30.0 MPa, at most 27.5 MPa, at most 25.0 MPa, or at most 21.5 MPa. The elasticity modulus to 10% elongation may be determined according to ASTM D412, more particularly according to ASTM D412-16 (2021).

The interlayer material may for example have an average elongation in a range from 150% to 500%, from 200% to 450%, from 250% to 400%, or from 300% to 350%. The interlayer material may for example have an average elongation of at least 150%, at least 200%, at least 250%, or at least 300%. The interlayer material may for example have an average elongation of at most 500%, at most 450%, at most 400%, or at most 350%. The average elongation may be determined according to ASTM D412, more particularly according to ASTM D412-16 (2021).

The interlayer material may for example have a force at break in a range from 50 to 200 N, from 60 to 150 N, or from 75 to 100 N. The interlayer material may for example have a force at break of at least 50 N, at least 60 N, or at least 75 N. The interlayer material may for example have a force at break of at most 200 N, at most 150 N, or at most 100 N. The force at break may be determined according to ASTM D412, more particularly according to ASTM D412-16 (2021).

The interlayer material may for example have a tear resistance in a range from 30 to 200 KN/m, from 50 to 150 KN/m, or from 70 to 100 KN/m. The interlayer material may for example have a tear resistance of at least 30 KN/m, at least 50 KN/m, or at least 70 KN/m. The interlayer material may for example have a tear resistance of at most 200 kN/m, at most 150 kN/m, or at most 100 KN/m. The tear resistance may be determined according to ASTM D624, more particularly according to ASTM D624-00 (2020).

In one aspect of the invention, the laminated glasses have an integrity according to UL 9 Standard Edition 8 as at March 2020 or according to UL 10 Standard, especially UL 10B Standard Edition 10 as at February 2008 or UL 10C Standard Edition 3 as at June 2016, after 90 minutes, preferably even after 120 minutes or after 180 minutes.

In one aspect of the invention, the laminated glasses have good mechanical integrity with respect to external exposures. This may be tested for example in a pendulum impact test as per standard ANSI Z97.1-2015 (R2020). The hole brought about in a laminated glass of the invention by a pendulum impact test according to ANSI Z97.1-2015 (R2020) with an impactor having a weight of 45 kg and a drop height of 1220 mm may in particular be so small that a ball having a diameter of 76 mm is unable to pass through the hole if applied with a force of at most 72 N, at most 36 N, at most 27 N, at most 18 N, at most 12 N, or at most 9 N. In one aspect of the invention, the laminated glass passes the pendulum impact test as per ANSI Z97.1-2015 (R2020), more particularly according to the highest category of this standard.

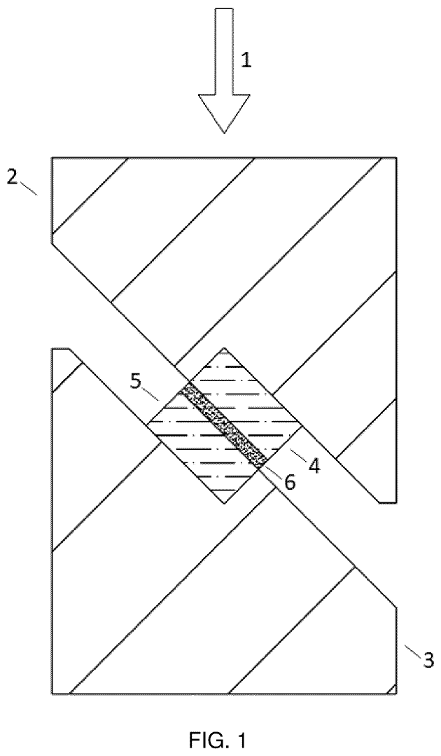

In one aspect of the invention, the laminated glasses have high shear strength. The shear characteristics may be determined using the measuring system shown in FIG. 1. The measuring apparatus comprises top and bottom holding devices, into which the sample under test is inserted. The length of the bottom holding device is chosen so as to support the sample up to a short way before the shearing edge (laminate layer; FIG. 1). The top holding device likewise ends a short way before the shearing edge, and so the laminate is exposed during shearing. The application angle is 45°. The force is introduced perpendicularly from above and divides uniformly into two force components: a component perpendicular to the shearing plane and a component in shearing direction. As a result, shearing takes place under load. The displacement velocity is 2 mm/s. The preload force is 10 N. The testing device used may be a tensile/compressive machine, more particularly a universal tensile/compressive machine, for example the Instron 5969 universal tensile/compressive machine. Measurement takes place in particular at a temperature of 22° C. and a relative atmospheric humidity of 40% to 60%, more particularly 50%.

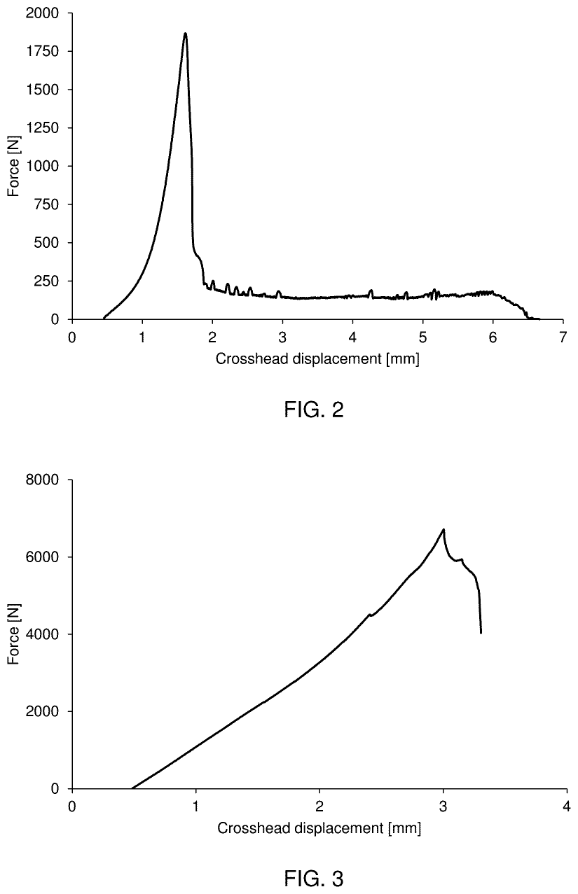

It is the shear force which is measured. The maximum shear force per unit area may be ascertained, for example, by plotting the force in a force—displacement curve against the crosshead displacement (FIGS. 2 and 3) and dividing the maximum force-apparent from the curve—by the sample area. For example, for a sample having a length of 20 mm and a width of 10 mm, the sample area is 20×10 mm²=200 mm².

For the laminated glasses of the invention, the maximum shear force per unit area is preferably at least 17.5 N/mm², for example at least 18.0 N/mm², at least 18.5 N/mm², at least 19.0 N/mm², at least 19.5 N/mm², at least 20.0 N/mm², at least 20.5 N/mm², at least 21.0 N/mm², at least 21.5 N/mm², at least 22.0 N/mm², at least 22.5 N/mm², at least 23.0 N/mm², at least 23.5 N/mm², or at least 24.0 N/mm². In certain embodiments, the maximum shear force per unit area is at most 50.0 N/mm², at most 45.0 N/mm², at most 40.0 N/mm², at most 35.0 N/mm², at most 30.0 N/mm², at most 29.0 N/mm², at most 28.0 N/mm², or at most 27.5 N/mm². The maximum shear force per unit area may for example be in a range from 17.5 to 50.0 N/mm², from 18.0 to 50.0 N/mm², from 18.5 to 45.0 N/mm², from 19.0 to 40.0 N/mm², from 19.5 to 40.0 N/mm², from 20.0 to 35.0 N/mm², from 20.5 to 35.0 N/mm², from 21.0 to 30.0 N/mm², from 21.5 to 30.0 N/mm², from 22.0 to 29.0 N/mm², from 22.5 to 29.0 N/mm², from 23.0 to 28.0 N/mm², from 23.5 to 27.5 N/mm², or from 24.0 to 27.5 N/mm².

The glass sheets may for example be thermally or chemically toughened, more particularly having a surface compressive stress of at least 50 MPa at the surface facing and/or remote from the interlayer. In one embodiment, at least one of the two sheets, more particularly both sheets, is/are thermally toughened. In one element, at least one of the two sheets, more particularly both sheets, is/are chemically toughened. In one embodiment, one of the two sheets is chemically toughened and one of the two sheets is thermally toughened. In one embodiment, neither of the two sheets is chemically toughened. In one embodiment, neither of the two sheets is thermally toughened. In one embodiment, each of the two sheets is neither chemically nor thermally toughened.

In one aspect, for example, at least one of the two sheets may have at least one fire-polished surface. In one embodiment, both sheets have at least one fire-polished surface. In one embodiment, both sheets each have exactly one fire-polished surface. In the laminated glass, the sheets are in that case preferably arranged in such a way that the fire-polished surface of the two sheets is facing outward in each case, while the non-fire-polished surface of the two sheets is pointing toward the interlayer in each case. In one embodiment, both sheets have two fire-polished surfaces. In one embodiment, one of the two sheets has a fire-polished surface and the other of the two sheets has two fire-polished surfaces. In one embodiment, one of the two sheets has a fire-polished surface and the other of the two sheets has no fire-polished surface. In one embodiment, neither of the two sheets has a fire-polished surface.

Fire-polished surfaces are notable for particularly low surface roughness. The roughness of a fire-polished surface is lower than that of a mechanically polished surface. The fire-polished surface or surfaces preferably have a root mean square roughness (R_{q} or else RMS) of at most 5 nm, preferably at most 3 nm and more preferably at most 1 nm. The roughness depth Rₜ is preferably at most 6 nm, more preferably at most 4 nm and very preferably at most 2 nm. The roughness depth is determined according to DIN EN ISO 4287.

In one aspect, for example, at least one of the two sheets, more particularly both sheets, may have good hydrolytic and/or chemical resistance. The acid resistance as per DIN 12116:2001-03 of at least one of the two sheets, more particularly of both sheets, may for example be such that the erosion in acid is at most 2.0 mg/dm², at most 1.5 mg/dm², or at most 1.2 mg/dm². The acid resistance as per DIN 12116:2001-03 of at least one of the two sheets, more particularly of both sheets, may for example be such that the sheet or sheets exhibit at least acid resistance class 2. The alkali resistance as per DIN ISO 695:1994-02 of at least one of the two sheets, more particularly of both sheets, may for example be such that the erosion in alkali is at most 100 mg/dm², at most 90 mg/dm², at most 80 mg/dm², or at most 75 mg/dm². The alkali resistance as per DIN ISO 695:1994-02 of at least one of the two sheets, more particularly of both sheets, may for example be such that the sheet or sheets exhibit at least alkali resistance class A1. The hydrolytic resistance as per ISO 719:2020-09 of at least one of the two sheets, more particularly of both sheets, may for example be such that the erosion (of glass grains) in water is at most 20 μg Na₂O per gram, at most 15 μg Na₂O per gram, or at most 10 μg Na₂O per gram. The hydrolytic resistance as per ISO 719:2020-09 of at least one of the two sheets, more particularly of both sheets, may for example be such that the sheet or sheets exhibit at least hydrolytic resistance class HGB1.

In one aspect, at least one of the two sheets, more particularly each of the two sheets, at a reference thickness of 4.0 mm may have a transmission of at least 80% for light having a wavelength in a range from 380 to 750 nm, more particularly over the entire wavelength range from 380 to 750 nm.

In one aspect, the interlayer material at a reference thickness of 380 μm may have a transmission of at least 80%, at least 85%, or at least 90% for light having a wavelength in a range from 380 to 750 nm, more particularly over the entire wavelength range from 380 to 750 nm.

The laminated glass may for example at a reference thickness of 8.0 mn have a transmission of at least 60% for light having a wavelength in a range from 380 to 750 nm, and/or at a reference thickness of 8.0 mm may have a transmission of at least 60% for light over the entire wavelength from 380 to 750 nm.

Haze is an optical parameter for determining the scattering characteristics and may be determined as per ASTM D1003, more particularly as per ASTM D1003:2013. The laminated glass may for example at a reference thickness of 8.0 mm have a haze in a range from 0.5% to 3.0%, from 1.0% to 2.2%, from 1.2% to 1.8%, or from 1.4% to 1.6%. In certain embodiments, the laminated glass may at a reference thickness of 8.0 mm also have a haze of 0.5% or less, for example a haze in a range from 0.1% to 0.5% from 0.2% to 0.4%, more particularly of about 0.3%.

In one aspect, the laminated glass may for example have a length in a range from 500 to 3000 mm and/or a width in a range from 500 to 2000 mm.

The invention also relates to a component which comprises a laminated glass of the invention, more particularly overhead glazing.

The invention also relates to the use of a laminated glass of the invention in a component, or particularly in overhead glazing.

The invention also relates to a method for producing a laminated glass. The method may in particular comprise the following steps:
providing at least two sheets, which independently of one another are glass sheets or glass-ceramic sheets,
providing an interlayer film,
arranging the film between the two sheets to give a layered assembly, and
autoclaving to give the laminated glass.

The autoclaving step may comprise, for example, temperatures in a range from 80° C. to 200° C., for example from 100° C. to 175° C., from 110° C. to 150° C., from 120° C. to 140° C., more particularly from 125° C. to 130° C., more particularly for a period of at least 4 hours and/or at most 8 hours. The autoclaving step may comprise, for example, a temperature of at least 120° C. or at least 125° C., more particularly for a period of at least 4 hours. The autoclaving step may comprise, for example, a temperature of at most 140° C. or at most 130° C., more particularly for a period of at most 8 hours.

The duration of the autoclaving step may be situated, for example, in a range from 5 to 9 hours. The autoclaving step may comprise a heating step, the duration of which extends from the beginning of the step of autoclaving to the point in time at which the autoclaving temperature is reached. The duration of the heating step may be, for example, 30 to 120 minutes, more particularly 45 to 90 minutes or about 60 minutes.

The method may comprise the following further step:
producing a pre-laminate from the layered assembly before the autoclaving.

The pre-laminate may be produced more particularly with the aid of rolls and/or reduced pressure.

The step of producing the pre-laminate may comprise, for example, temperatures in a range from 80° C. to 130° C., from 90° C. to 120° C., or from 100° C. to 110° C., more particularly for a period of 2 to 5 minutes. The step of producing the pre-laminate may comprise, for example, a temperature of at least 80° C., at least 90° C., or at least 100° C., more particularly for a period of 15 to 120 seconds. The step of producing the pre-laminate may comprise, for example, a temperature of at most 130° C., at most 120° C., or at most 110° C., more particularly for a period of 15 to 120 seconds.

The duration of the step of producing the pre-laminate may be situated, for example, in a range from 15 to 120 seconds.

The autoclaving step and/or the step of producing the pre-laminate may comprise, for example, a pressure in a range from 100 to 200 g/cm², more particularly from 115 to 180 g/cm² or from 130 to 160 g/cm². The pressure in the autoclaving step and/or in the step of producing the pre-laminate may be, for example, at least 100 g/cm², at least 115 g/cm² or at least 130 g/cm² betragen. The pressure in the autoclaving step and/or in the step of producing the pre-laminate may be, for example, at most 200 g/cm², at most 180 g/cm² or at most 160 g/cm².

The step of providing the sheets comprises, in particular, a float process. In order to reduce thickness fluctuations, it is advantageous to keep the drawing velocity and/or the temperature regime as constant as possible. This applies to the ceramization procedure as well in the case of glass-ceramic sheets. A particularly uniform temperature regime may be achieved in particular through harmonization of the floor, ceiling and side heating circuits.

### Preferred Embodiments

In one preferred embodiment, the invention relates to laminated glass comprising at least two glass sheets, more particularly borosilicate glass sheets, and an interlayer located between the two sheets and composed of an interlayer material,
where the ratio of the sum of the wavinesses (each in mm per 300 mm) of the two sheets to the thickness (in mm) of the interlayer is at most 1.0% per mm, and
where the interlayer material comprises at least one polyurethane and has a melting temperature of at most 220° C.

In one preferred embodiment, the invention relates to laminated glass comprising at least two glass-ceramic sheets and an interlayer located between the two sheets and composed of an interlayer material,
where the ratio of the sum of the wavinesses (each in mm per 300 mm) of the two sheets to the thickness (in mm) of the interlayer is at most 1.0% per mm, and
where the interlayer material comprises at least one polyurethane and has a melting temperature of at most 220° C.

In one preferred embodiment, the invention relates to laminated glass having a thickness in a range from 5.0 to 15.0 mm comprising at least two sheets and an interlayer located between the two sheets and composed of an interlayer material, with an interlayer thickness in a range from 0.3 to 5.0 mm,
where the ratio of the sum of the wavinesses (each in mm per 300 mm) of the two sheets to the thickness (in mm) of the interlayer is at most 1.0% per mm,
where the interlayer material comprises at least one polymer and has a melting temperature of at most 220° C., and
where the two sheets independently of one another are glass sheets or glass-ceramic sheets.

In one preferred body meant, the invention relates to laminated glass comprising at least two glass-ceramic sheets and an interlayer located between the two sheets and composed of an interlayer material which comprises polyurethane, where the laminated glass has a maximum shear force per unit area of at least 17.5 N/mm² and has a transmission of at least 60% for light having a wavelength in a range from 380 to 750 nm at a reference thickness of 8.0 mm.

In one preferred embodiment, the invention relates to laminated glass comprising at least two sheets and an interlayer located between the two sheets and composed of an interlayer material,
where the ratio of the sum of the wavinesses (each in mm per 300 mm) of the two sheets to the thickness (in mm) of the interlayer is at most 1.0% per mm,
where the interlayer material comprises at least one polyurethane and additionally a flame-retardant material or a combination of two or more flame-retardant materials,
where the interlayer material has a melting temperature of at most 220° C., and
where the two sheets independently of one another are glass sheets or glass-ceramic sheets.

In one preferred embodiment, the invention relates to laminated glass having an integrity according to UL 9 Standard Edition 8 as at March 2020 after 90 minutes which passes the pendulum impact test as per ANSI Z97.1-2015 (R2020),
where the laminated glass comprises at least two sheets and an interlayer located between the two sheets and composed of an interlayer material,
where the ratio of the sum of the wavinesses (each in mm per 300 mm) of the two sheets to the thickness (in mm) of the interlayer is at most 1.0% per mm,
where the interlayer material comprises at least one polymer and has a melting temperature of at most 220° C., and
where the two sheets independently of one another are glass sheets or glass-ceramic sheets.

The laminated glass of the invention is also suitable for use in vertical glazing. The invention also relates, for example, to a door, a window or a wall which comprises a laminated glass of the invention, or to the use of the laminated glass of the invention in a door, window or a wall.

FIG. 1 shows the measuring apparatus for determining the shear strength. The laminated glass with the two sheets 4 and 5 and with the interlayer 6 is inserted into the lower holder 3. The lower holder 3 is designed such that the laminated glass is supported until a short way before the shearing edge (interlayer 6). The upper pressure piece 2 likewise ends a short way before the shearing edge, and so the interlayer 6 is exposed during shearing. The force 1 is introduced perpendicularly from above and divides uniformly into two force components: a component perpendicular to the shearing plane, and a component in shearing direction. As a result, the shearing takes place under load.

FIGS. 2 and 3 show typical force-displacement curves. The crosshead displacement in mm is shown on the x-axis. The force in N is shown on the y-axis.

FIG. 2 shows a typical force-displacement curve of example A. The maximum shear force of about 1800 N is reached for a crosshead displacement of between 1 and 2 mm. The detachment of the upper glass-ceramic sheet from the interlayer results in a pronounced drop in force. The plateau phase, at a crosshead displacement of 2 to 6 mm, represents a displacement of the glass-ceramic sheet along the interlayer. Beyond a crosshead displacement of about 6 mm, a further drop in force is apparent, resulting from the increasingly smaller contact area between glass-ceramic sheet and interlayer. At a crosshead displacement of about 6.5 mm, the force finally drops to 0 N. The upper glass-ceramic sheet has separated completely from the interlayer.

FIG. 3 shows a typical force-displacement curve of example C. The maximum shear force of about 6500 N is reached for a crosshead displacement of about 3 mm. The drop in force is due to the fracture of the glass-ceramic and its increasing instability.

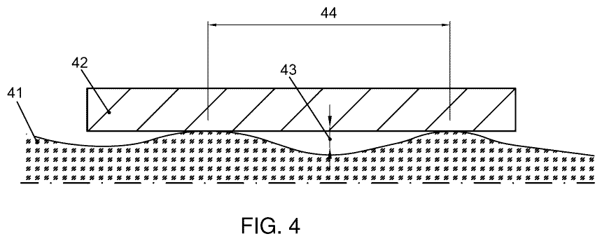

FIG. 4 shows, schematically, the determination of the waviness of a sheet 41. The waviness of the sheet 41 is determined by placing a measuring body 42 with planar measuring face with a length of 300 mm onto the sheet 41, so that the measuring body 42 does not overhang any of the edges of the sheet 41. The measuring body 42 lies on the sheet 41 at two points, spaced apart by a distance 44, while, owing to the waviness of the sheet 41 at another location, a gap is formed between the measuring body 42 and the surface of the sheet 41. The height 43 of such a gap may be determined, for example, using a feeler gauge, more particularly by placing the feeler gauge between the surface of the sheet 41 and the measuring body 42 and increasing the thickness of the feeler gauge so as just to fill the gap between the surface of the sheet 41 and the measuring body 42 at the location of the greatest distance 43 between the surface of the sheet 41 and the measuring body 42. The thickness of the feeler gauge then corresponds to the height 43 of the gap. Gaps of different height 43 may result, depending on the position in which the measuring body 42 is placed on the surface of the sheet 41. The gap relevant for the determination of waviness is the gap having the greatest height 43 of all the gaps. This height 43 is also referred to as Hₘₐₓ and expressed in the unit mm. The waviness of the sheet is expressed as the ratio of Hₘₐₓ (in mm) to the length of the measuring body 42, of 300 mm. After shortening of the unit mm, the waviness may be expressed as a percentage. If, for example, Hₘₐₓ is 3 mm, the waviness is obtained as the ratio of 3 mm to 300 mm and is therefore 1.0%.

### EXAMPLES

Laminated glasses of the invention and non-inventive, comparative laminated glasses were investigated for their shear strength, their mechanical resistance, and their fire resistance. The ratio of the sum of the wavinesses (each in mm per 300 mm) of the two sheets to the thickness (in mm) of the interlayer was in each case at most 1.0% per mm.

### 1. Shear Strength

The laminated glasses investigated each consisted of two glass-ceramic sheets each with a thickness of 4 mm and with an interlayer located between the two sheets and composed of a polymer-comprising material, the thickness of the interlayer being 0.76 mm. The laminated glasses each had a length of 20 mm and a width of 10 mm.

There were differences between the laminated glasses in terms of the polymer. For the inventive example C, the polymer was polyurethane. For the non-inventive examples A and B, the polymer was PVB (polyvinyl butyral) and EVA (ethylene-vinyl acetate copolymer) respectively. The interlayer material of example C contained a flame-retardant material as well as the polymer.

The measuring principle is shown in FIG. 1. The measuring apparatus comprised top and bottom holding devices, into which the sample under test was inserted. The length of the bottom holding device was chosen so as to support the sample up to a short way before the shearing edge (laminate layer; FIG. 1). The top holding device likewise ended a short way before the shearing edge, and so the laminate was exposed during shearing. The application angle was 45°.

The force was introduced perpendicularly from above and divided uniformly into two force components: a component perpendicular to the shearing plane and a component in shearing direction. As a result, shearing took place under load. The displacement velocity was 2 mm/s. The preload force was 10 N. The testing device used was the Instron 5969 universal tensile/compressive machine. Measurement took place at a temperature of 22° C. and a relative atmospheric humidity of 40% to 60%, more particularly 50%.

Laminated glasses having a construction according to example A (PVB interlayer), example B (EVA interlayer), and example C (polyurethane interlayer) were tested. The number of samples was 16 samples for example A, 21 samples for example B, and 39 samples for example C.

The PVB interlayers of example A could be sheared from the glass-ceramic without the glass-ceramic fracturing. The adhesion between the glass-ceramic and the PVB interlayer was therefore very low.

The characteristics shown by the samples of example C were entirely different. The adhesion between the glass-ceramic and the polyurethane interlayer was of a magnitude such that the interlayer could not be sheared off. For each of the tested samples of example C, therefore, failure was through fracture of the glass-ceramic under the shearing load. In spite of the large shearing forces acting on them, there was no marked displacement of the two glass-ceramic sheets relative to one another.

In this regard, the shearing characteristics of example B were situated between those of example A and those of example C. For the majority of the samples, the glass-ceramic did fracture. However, under the shearing load, the interlayer was already partly detached and the upper glass-ceramic sheet was significantly displaced, meaning that the maximum shearing force was lower than in the case of example C. For two samples, indeed, the interlayer parted before the glass-ceramic fractured. The adhesion between the glass-ceramic and the EVA interlayer of example B was therefore better than for example A, but significantly poorer than for example C.

The qualitatively different shearing characteristics of the three examples A to C are reflected in quantitatively different shearing characteristics (expressed as maximum shearing force per unit area). As soon as there is detachment of the interlayer, there is a drop in force. As a result, the maximum shearing force per unit area is relatively low (FIG. 2). If, however, the interlayer cannot be sheared off, as for example C, the shearing force increases further, until eventually the glass-ceramic sheet fractures (FIG. 3). The maximum shearing force per unit area is higher correspondingly, particularly if, in the light of the strong adhesion between the glass-ceramic and the interlayer, there is not even any displacement of the glass-ceramic sheets relative to one another before the fracture of the glass-ceramic.

The results are summarised in the table below. The maximum shearing force per unit area is expressed as the mean±standard deviation.

| | Interlayer | Maximum shearing force per unit |
|---|---|---|
| | polymer | area [N/mm²] |
| Example A | PVB | 5.7 ± 0.6 |
| Example B | EVA | 13.9 ± 3.5 |
| Example C | PU | 24.3 ± 2.9 |

Example C had by far the best shear strength.

### 2. Pendulum Impact Test

A pendulum impact test was carried out in accordance with standard ANSI Z97.1-2015 (R2020).

The laminated glass tested consisted of two glass-ceramic sheets with a thickness of 3 mm in each case and with an interlayer located between the two sheets and composed of an interlayer material, according to example C described above, with an interlayer thickness of 0.76 mm. The length of the laminated glass was 1938 mm and the width of the laminated glass was 876 mm.

The pendulum impact test was carried out according to ANSI Z97.1-2015 (R2020) using an impactor having a weight of 45 kg and a drop height of 1220 mm.

The hole brought about in the laminated glass by the pendulum impact was smaller than 76 mm in diameter. The test was therefore passed according to the highest category of this standard. The laminated glass of the invention with an interlayer according to example C has outstanding mechanical stability.

### 3. Fire Resistance

Laminated glasses with an interlayer according to example A (PVB plastic) or according to example C (polyurethane plastic) were tested for their fire resistance.

### a) Example A

The laminated glass with an interlayer according to example A had a length of 2000 mm and a width of 1000 mm. The thickness of the interlayer was 0.76 mm. The two sheets were glass-ceramic sheets having a thickness each of 4 mm. An interlayer film was arranged between the two sheets. A pre-laminate was produced from the resulting layered assembly, and was autoclaved to give the laminated glass.

The laminated glass was encased in a steel frame with a surrounding 15 mm glass rebate and tested in a test oven according to UL9.

After 5 minutes, the interlayer was observed to blister. After 6 minutes, the sheet on the fire side fractured. The interlayer now exposed to the fire burned, forming a strong flame. After 90 minutes, the oven was shut off. The chamber was still closed off. During the hose stream test conducted after the switching-off of the oven, there were no fractures nor any openings.

### b) Example C

The laminated glass with an interlayer according to example C had a length of 2000 mm and a width of 1000 mm. The thickness of the interlayer was 0.76 mm. The two sheets were glass-ceramic sheets having a thickness each of 5 mm. An interlayer film was arranged between the two sheets. The resulting layered assembly was autoclaved to give the laminated glass.

The laminated glass was encased in a steel frame with a surrounding 15 mm glass rebate and tested in a test oven according to UL9.

After 3 minutes, a reaction of the interlayer became visible, with blistering. After 4 minutes, the interlayer lost color. Shortly after the blistering, the film begins to run off downward, causing the blisters to then disappear. There were no observations of lateral flaming. After 90 minutes, the oven was shut off. The chamber was still closed off. During the hose stream test conducted after the switching-off of the oven, there were no fractures nor any openings.

A particular advantage of the laminated glass with an interlayer according to example C is therefore its good fire resistance.

### LIST OF REFERENCE SIGNS

1 force
2 upper pressure piece
3 lower holder
4 sheet
5 sheet
6 interlayer
41 sheet
42 measuring body
43 height
44 spacing

1-10. (canceled)

11. A laminated glass, comprising:
a plurality of sheets comprising two sheets, wherein the two sheets independently of one another are glass sheets or glass-ceramic sheets; and
an interlayer located between the two sheets and composed of an interlayer material, wherein a ratio of a sum of a wavinesses (each in mm per 300 mm) of the two sheets to a thickness (in mm) of the interlayer is at most 1.0% per mm and the interlayer material comprises at least one polymer and has a melting temperature of at most 220° C.

12. The laminated glass of claim 11, wherein each of the two sheets has a thickness in a range from 2.0 to 15.0 mm, with the interlayer having a thickness in a range from 0.3 to 5.0 mm, and/or with the laminated glass having a thickness in a range from 5.0 to 15.0 mm.

13. The laminated glass of claim 11, wherein at least one of the two sheets is a borosilicate glass sheet or a glass-ceramic sheet.

14. The laminated glass of claim 11, wherein the at least one polymer is polyurethane.

15. The laminated glass of claim 11, wherein the interlayer material further comprises a flame-retardant material additionally to the at least one polymer.

16. The laminated glass of claim 11, wherein at least one of the following is satisfied:
50% by weight of a loss of mass of the interlayer material in a thermogravimetric analysis (TGA) according to DIN EN ISO 11358-1:2014-10 takes place at temperatures below 425° C.;
in a power-compensated differential scanning calorimetry (DSC) according to DIN EN ISO 11357-1:2017-02, in which a sample of the interlayer material and a reference crucible are introduced into thermally insulated ovens and the ovens are regulated such that a temperature is always the same on both sides, an electrical power required for such regulation in a temperature range from 100° C. to 200° C. is on average less than 0.6 mW per mg of interlayer material; or
a residue on ignition of the interlayer material as per DIN EN ISO 3451-1:2019-05 at a temperature of 625° C. is at least 0.20% by weight.

17. The laminated glass of claim 11, wherein the laminated glass has an integrity according to UL 9 Standard Edition 8 as at March 2020 or according to UL 10B Standard Edition 10 as at February 2008 or UL 10C Standard Edition 3 as at June 2016, after 90 minutes.

18. The laminated glass of claim 11, wherein a maximum shear force per unit area is at least 17.5 N/mm².

19. The laminated glass of claim 11, wherein at least one of the two sheets exhibits acid resistance class 2 as per DIN 12116:2001-03, alkali resistance class A1 as per DIN ISO 695:1994-02, and/or hydrolytic resistance class HGB1 as per ISO 719:2020-09.

20. A method for producing a laminated glass, comprising:
providing two sheets, which independently of one another are glass sheets or glass-ceramic sheets;
providing an interlayer film;
arranging the interlayer film between the two sheets to give a layered assembly; and
autoclaving to give the laminated glass.
